(19) United States
(12) Patent Application Publication
(10) Pub. No.: US 2023/0245587 A1
(43) Pub. Date: Aug. 3, 2023

(54) SYSTEM AND METHOD FOR INTEGRATING SPECIAL EFFECTS TO A STORY

(71) Applicant: Learnerix LTD., Toronto (CA)

(72) Inventors: Ali KHEIRABADI, Dubai (AE); Arash YAGHTIN, Dubai (AE); Amirhoushang SAADAT, Kermanshah (IR)

(21) Appl. No.: 18/103,885

(22) Filed: Jan. 31, 2023

Related U.S. Application Data
(60) Provisional application No. 63/305,958, filed on Feb. 2, 2022.

(51) Int. Cl. G09B 17/00; G10L 15/22; G06F 3/16; G10L 15/02

(52) U.S. Cl. CPC G09B 17/006; G10L 15/22; G06F 3/167; G10L 15/02; G10L 2015/228

(57) ABSTRACT

A system and method for generating an interactive story is disclosed. The system receives an audible input from a user on an electronic device comprising voice of the user reading a story. The system accesses a plurality of pre-determined triggers associated with the story read by the user, wherein the electronic device is configured to cause one or more special effects upon matching the audible input via a voice recognition algorithm and commands one or more special effect to output associated with the story. Interactive sound effects, visual effects integrated with the story book, bring the story to life by adding music, sounds and character voices.

### RELATED APPLICATIONS

This application claims priority to the U.S. provisional patent application No. 63/305,958 filed on Feb. 2, 2022, entitled “SYSTEM AND METHOD FOR INTEGRATING SPECIAL EFFECTS TO A STORY”, the application being hereby incorporated by reference in its entirety.

### FIELD OF THE INVENTION

The present invention relates in general to books and stories and in specific to integrating special effects to stories that immerses participants into the story environment specifically for children under the age of 10 years old.

### BACKGROUND OF THE INVENTION

Children learn to talk as they participate in the usual, everyday communication. In order to comprehend and communicate effectively, development of strong verbal skills is vital, right from the birth of children. Research has proven the role of audio-visual books in this regard. The ease of using audio-visual books contributes to its success in developing verbal skills in children.

Audio-Visual books provide good interpretive reading skills to children. Inability to read big, long texts could potentially affect their interest in reading and learning. Audio-Visual books help children to understand complex language. Through pictures and music, children are able to grasp information better. Audio-visual books attract children towards stories, texts and content and boost their interest in understanding language, thus fostering their verbal skills.

Audio visual books further develop active listening and critical thinking skills. Effective verbal or spoken communication depends on the ability to listen to what others speak. Active listening is an important skill and should be introduced in children right from a young age, in order to interact with others, expressing thoughts, sharing information and proper understanding of context.

Audio-Visual books are very engaging and spark the imagination of children. These books help children understand what others are trying to say, build a context and communicate better themselves. Children love listening to these stories and thus develop the ability to listen critically and carefully. Visual images stick in the long-term memory of children. They are able to pay more attention and understand better through images rather than textual form. Visuals transmit the message faster to children and help them comprehend information so that they can put their thoughts into words clearly.

Listening to Audio-Visual books helps children to share how they think with others effectively and improve their vocabulary, reading and speaking skills. They are more interesting and associate how words sound with how they appear on a page and help children to correlate the meaning of words, which increases their understanding.

Audio-Visual books are easily accessible, portable and can be listened to over-and- over again. When children show reluctance towards hard book covers, audio-visual books act as the perfect tool to attract children through their stories, pictures and music, providing a pleasurable reading and learning experience.

In recent years interactive books and mixed reality toys are finding an extended market owing to the proliferation of smartphones in the market. Apps have been developed that play the background music with sound effects relevant to some key words written in the story. The app will play the sound effects while reading the book and recognizes the readers sound. The available apps have the feature of playing relevant sounds. Music and/or audible effects in combination with silent reading is further described. Such systems, however, are dependent on use of electronic books and algorithms that synchronize a user's reading speed to the sound effects. Improvements in systems and methods for integrating special effects to stories are desirable.

### SUMMARY OF THE INVENTION

The present invention is a system and method to add audio and visual effects to the story books. The system “Live the Story” is an App that works with electronic devices including but not limited to kindle, computers, smart phones and tablets and provides interactive sound effects, illustrations and recordings while the users are reading a book. In the description the term “app” or “application” or “mobile app” may refer to, for example, an executable binary that is installed and runs on a computing device.

The story book may refer to a children's book, a board book, a chapter book, a novel, a magazine, a comic book, and the like.

The software application of the system has options to add background images, characters, gif animations, sound effects, visual effects and control the way they are going to be presented. The books will be uploaded on online server of the system and then will be downloaded by the end users.

The system immerses participants, the readers of the book and the listeners, while viewing or listening to the reader and allow participants specifically young children to bring a subject to life and explore the subject more interactively. The pictures come alive in the form of videos or 3D figures displayed on top of the picture, creating an illusion of images becoming alive by augmenting videos and 3D objects on top of the image/ picture, when viewed through the electronic devices. In the invention, the participants become part of the story.

In one embodiment the participant's own image can become part of the story (video or 3D) along with the other story characters while displaying the AR content. In another embodiment the participants can create an avatar and become part of the story.

Interactive sound effects, visual effects and animations integrated with the books, bring the story to life by adding music, sounds and even character voices. The system of the present invention has a voice recognition technology which helps the sound effects become a seamless part of users narration.

Therefore, it is an objective of the present invention to make reading books to be more joyful by adding audio and visual attractions and create a new generation of book lovers and to provide valuable screen time.

It is another object of the present invention to prevent children to spend more time on using electronic devices such as mobile and tablet devices to play games and to enrich the time they spend on tablets by directing them to enjoy reading books.

It is another object of the present invention to strengthening the relation between parents and their children by involving the parents to read books with their children and encouraging the children to read books and enjoy their time by using the present interactive app.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a general overview of the system according to the present invention;

FIG. 2 illustrates the operation of the book editor tool according to the present invention;

FIG. 3 illustrates the operation of the command button according to the present invention;

FIG. 4 is an overview of selection of an image and set image properties according to the present invention;

FIG. 5 illustrates an arrangement of soundtrack and visual effect files associating with the story book according to the present invention;

FIG. 6 shows the control system of the present invention;

FIG. 7 shows the back-end tool integrated with the system application according to the present invention;

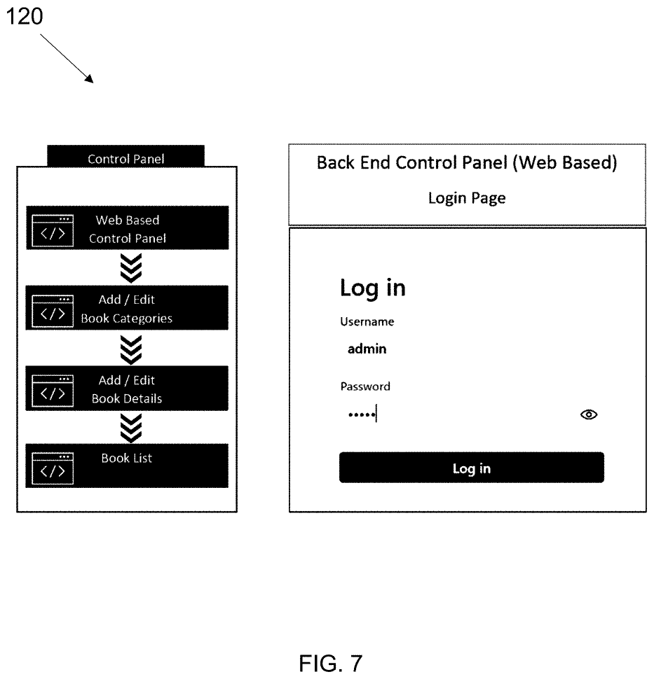

FIG. 8 shows the operation of downloading the books from the online store into the electronic device and create a category list of the Books;

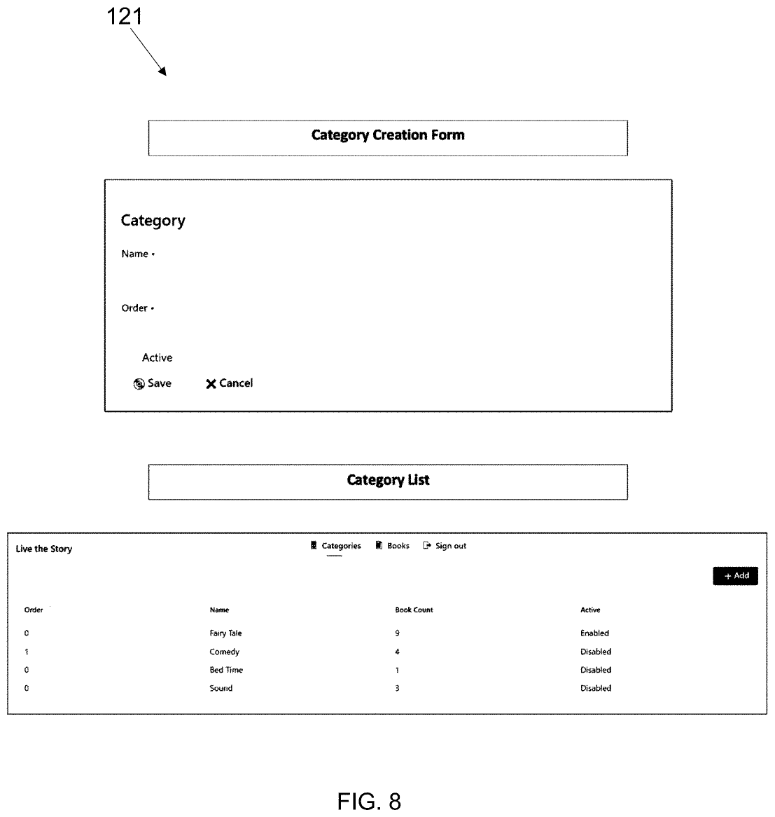

FIG. 9 is a block diagram illustrating electronic components and their interaction with other components of the system according to the present invention;

FIG. 10 shows a display of a homepage of the application to welcome the users according to the present invention;

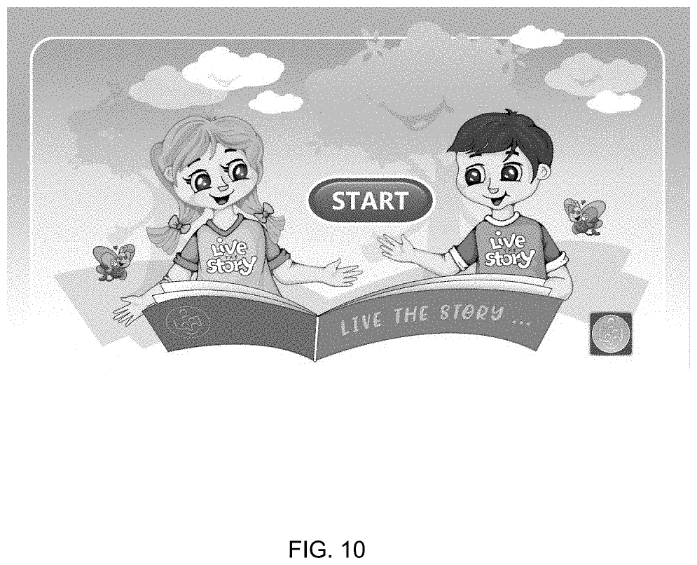

FIG. 11 shows a character creation mode according to the present invention;

FIG. 12 shows a character creation mode which displays avatars and asks the user to select an avatar;

FIG. 13 shows an example of the book list of the system, according to the present invention;

FIG. 14 shows an example of the interactive environment of the present invention, and

FIG. 15 shows the schematic summary of the invention.

### DETAILED DESCRIPTION OF PREFERRED EMBODIMENTS

The present invention relates to a system to adding special effects to story books, such as a traditional paper book, e-book or any other sources, and an associated method for playing the special effects. The special effects is in response to a user reading a story to enhance the enjoyment of the reading experience specifically for younger children. The special effects can be customized to the particular story and can be synchronized to initiate the special effect in response to the text source being read. The system of the present invention uses the latest Machine Learning techniques, voice recognition and AR to create special effects.

The system is programmed to begin processing and outputting a special effect related to the word being read by the reader. The system will perform while reading a book, special effects, such as, audio sounds, music, lighting or other environmental effects when specific words or phrases of the text source are read. For example, a system may be configured to detect a particular pre-determined word or phrase of a text source, process, and output a special effect related to one or more portions of the book.

The application is an Android App that is downloadable from the Google Play Store and can be installed on any electronic device such as mobile device, a desktop or a laptop configured to receive an audible input from a user and output a plurality of special effects associated with the story based on algorithm of the system. The audible input from a user comprises a voice of a user reading one or more portions of a story is pre-recorded and electronically outputted.

The system determines whether the audible input matches one or more pre-determined triggers via a voice recognition algorithm; and in response to determining that the audible input matches the pre-determined trigger, command the system to output a plurality of special effects associated with the story book; wherein the special effect comprises an audio or a visual content.

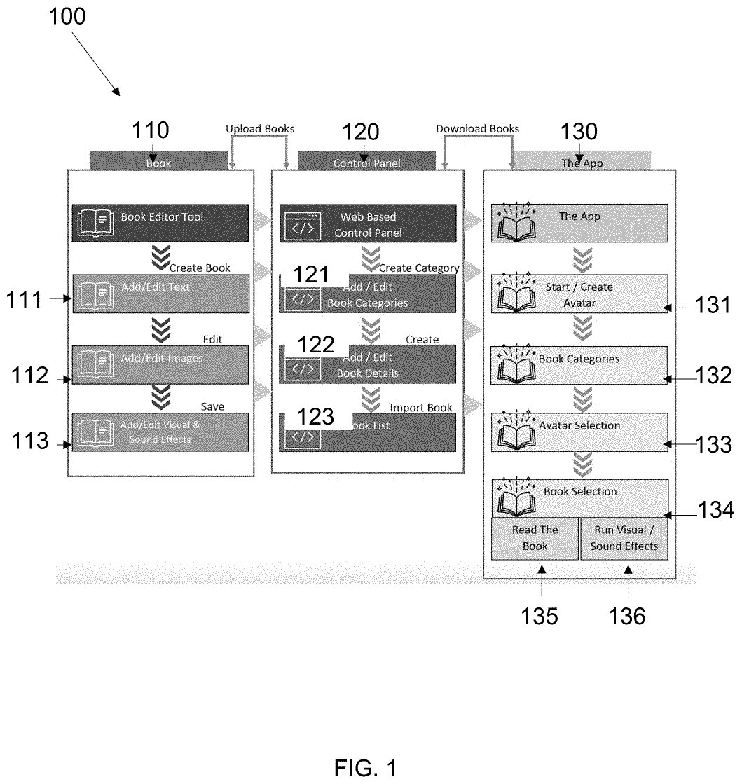

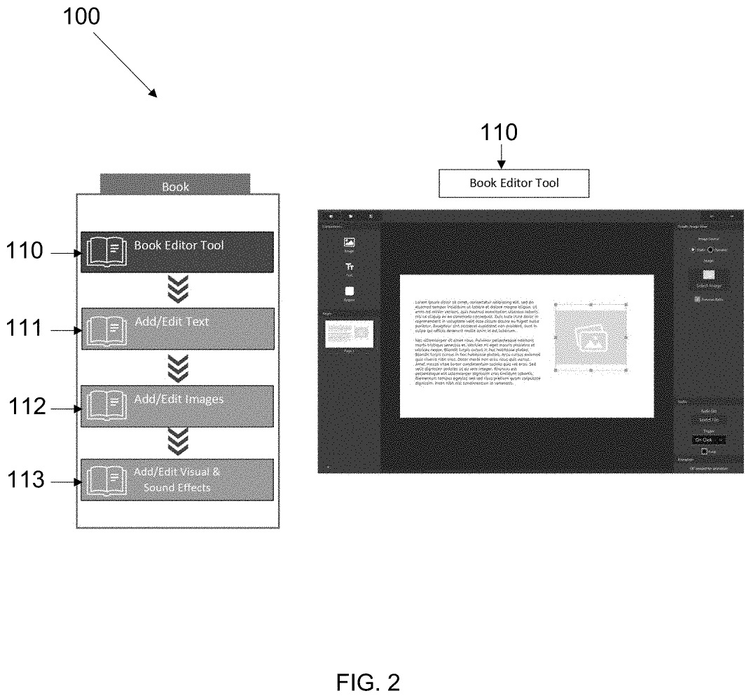

Referring to FIGS. 1 and 2, a system 100 for generation of a special effect according to an embodiment of the invention is shown. In the system, an electronic device may be used by the user in conjunction with a story book and one or more special effect modules.

The system application of the present invention 100 is comprised of 3 major parts:

a. Book editor software (Desktop) 110
b. Web based Control Panel 120
c. Android App (LIVE THE STORY) 130

The Book editor software 110 is programmed to create and edit the books (stories) that will be used on the Android App 130. The book editor software 110 provides features comprising:

Add/Edit text layers (font and size) 111;
Add/Edit Background layers(Images);
Add/Edit character layers (Static/Dynamic Images), animations and motions layer (gif images) 112, and
Add visual and sound effects on the images and characters 113.

The book Editor 110 creates multimedia books. The user of the system 100 will be able to add/edit texts, Add Images, import Visual documents (GIF format) and sound effects (Audio format) on selected parts of the book either text or images. The system 100 can utilize a voice recognition feature to detect specific words when read by the reader and run the relevant assigned animations (GIF or sound files).

The system 100 may add background images, characters, texts, gif animations and control the way they are going to be played. The books will be uploaded on online server of the system and then will be downloaded by the users.

The web based Control Panel 120 is designed to create categories that will be available on the app, and to upload the books so that they are accessible and downloadable for the app user on their android device. The features of the control panel 120 of the system are to: Add/Edit book categories 121, Upload/Edit or delete book's details 122 and import books to create book list 123.

Android App 130 is downloadable from the Google Play Store and can be installed on any android device. After the App 130 is executed, the first initial step is to download the books from the online store into the android device and then the Books (stories) can be played at any time. The user will have the option to select an avatar 131 for the characters of the book. The App 130 has features to download and update the book's (stories) categories 132, select Avatars (using the camera or a saved avatar created by avatar maker apps) 133, create avatars or use a picture of participants' face in the story.

The user then selects a book 134 to read. The system 100 runs and shares the user's story which is read by the reader 135 with the created or selected avatar in combination with visual and sound effects 136.

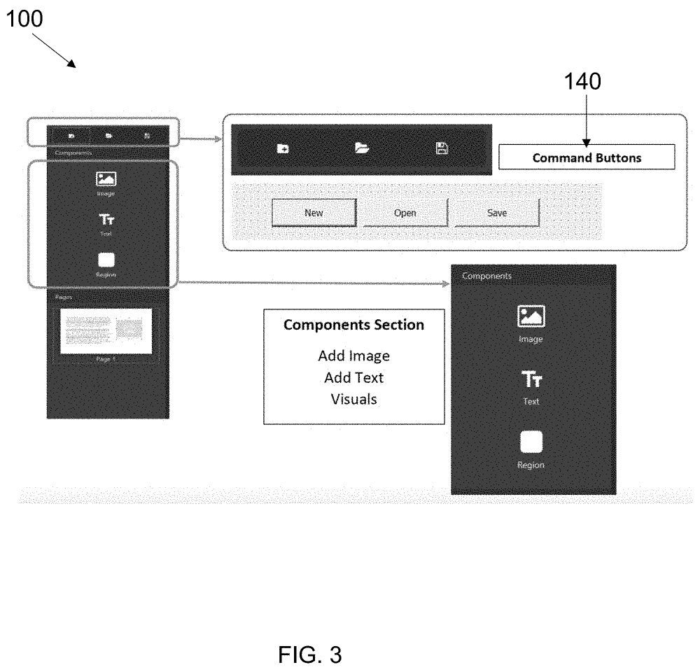

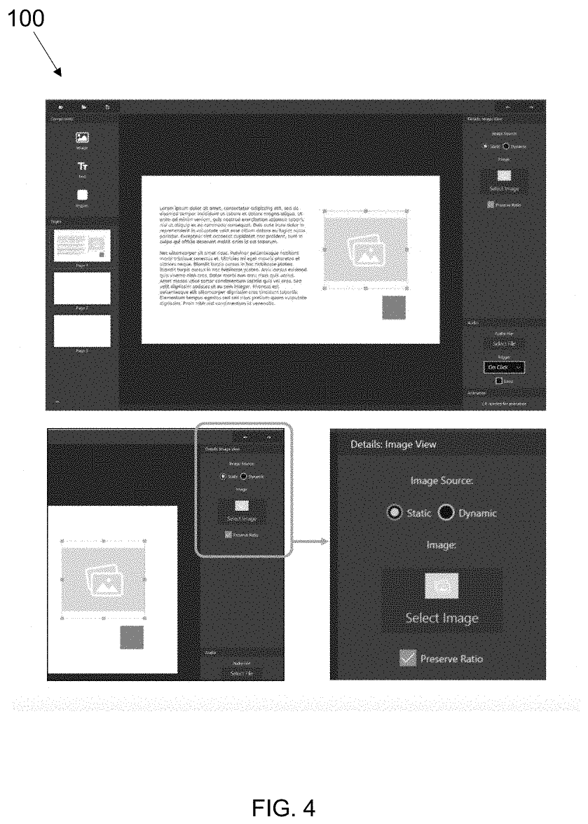

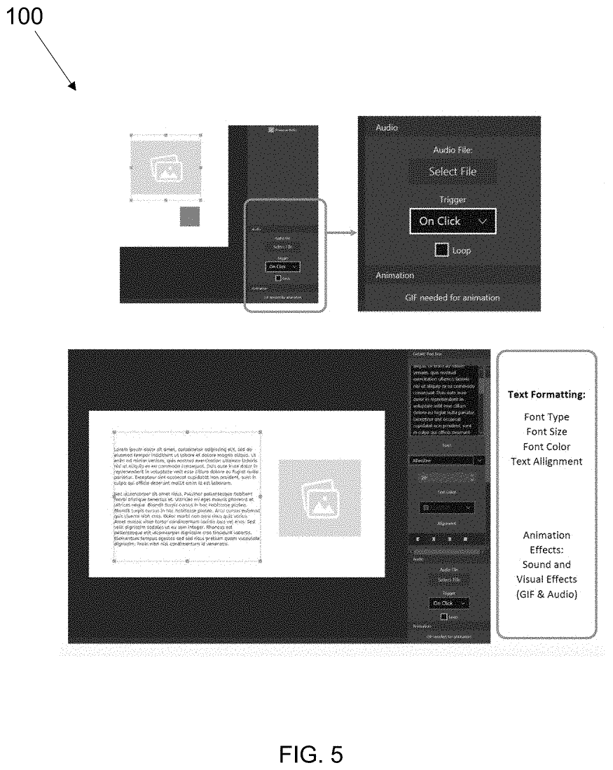

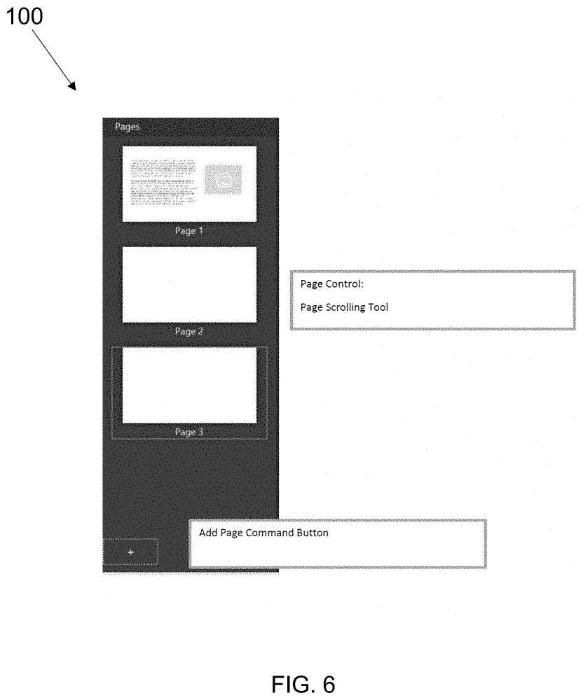

FIGS. 3 to 6 show the command system 140. The system may be programmed to command one or more of the special effect output modules to play the special effect.

A particular special effect is played to the feature phrase being read. The system 100 may be programmed to command one or more of the special effect output modules to play the special effect upon detection of one or more trigger phrases. The system includes a special effect track that may be multi-layered comprising one or more special effects that may play separate or simultaneously during reading of the book. Each special effect layer may include one or more special effects including but not limited to an auditory effect, a visual effect, an environmental effect, other special effects, and combinations thereof.

The special effect track may be incorporated into various file formats for playing by corresponding special effect software. The system 100 enables the users to provide additional special effect tracks, add, or modify existing special effect tracks to the system. A user or reader of a book may then download or obtain the updated special effect track for a selected book. For example, in response to detection of a single trigger phrase, one or more special effects of special effect layer 1 may be pre-programmed to play for a pre-determined period of time, one or more special effects of special effect layer 2 may be pre-programmed to begin playback after a pre-determined time of the playback of one or more effects of special effect layer 1, and one or more audible effects of special effect layer 3 may be pre-programmed to begin playback after a pre-determined time after the playback of one or more special effects of layers 1 and/or 2.

Auditory effects can include background music, human voices, animal sounds, atmospheric noise, sound effects and the like.

Visual effects can include any special effect that is designed to be viewable by a user. For example, visual effects can include animation, video, avatars, or other forms of motion, light sources and the like.

According to FIG. 1 again and 7 the Control Panel of the system 120 is a back-end tool integrated with the App 130 and will be used to Add/Edit book categories 121, Add/Edit Book Details (Book Name, Description, Category, Thumbnail Picture, Sort order) 122, Upload Books and Active/Inactive books. Admin users can log in to create the Categories and upload the books and create a book list 123. Uploaded books will be accessible and downloadable on the app, if they are set as active. Inactive books will not be visible on the app.

The system Incorporates AR technologies to create a unique interactive experience and bring the stories to life. Multiple users can use multiple devices and enter the story environment to view the same story unfold through different perspectives depending on their physical location. Users can, for example, face the tablet/phone device to an empty table, and then perceive the 3D world on the table.

Experiencing the story with more users will always be more fun, and throughout the whole story, users can have their friends also experience the story on their devices even if they are apart from each other. Through remote technologies, the AR experiences will be in sync including video and audio calls in the background so they can talk to each other as well.

To further enhance the experience of an interactive story, the AR component can be complemented with actual physical toys/markers. It can be a board with many pieces to signify the different characters or objects of the story. Through AR, these pieces turn into their 3D characters or objects. Their position is also tracked and thus the story can be played by a ‘physical touch’. Multiple kids can look around the table with their phones/tablets and run around it and look at the story, while the parent is moving the pieces and the story along. This creates a lively experience that involves both the parents and the kids, making it the perfect bonding experience to be a part of the story, together.

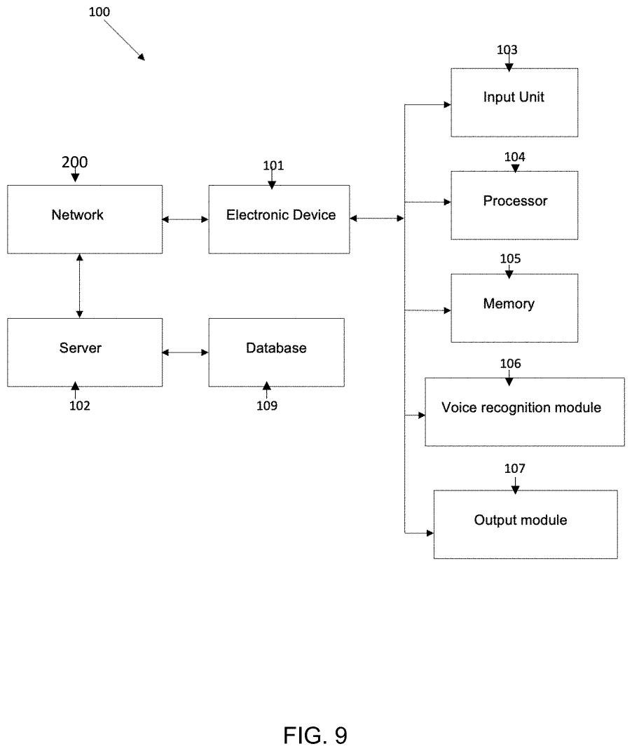

FIG. 9 is a block diagram of the components of the system 100. The system 100 may include a server 102 and an electronic device 101, which may include an input unit 103, a processor 104, a memory 105, a voice recognition module 106, a database 109, and one or more output modules 107 such as audio output module which is adapted to produce an audio special effect and visual output module to produce visual special effect. The database 109 may include one or more special effect track files associated with respective text sources.

The input unit 103, voice recognition module 106, and the other related circuitry, may be configured to work together to receive and detect audible from the reader. For example, the voice recognition module 106 may be configured to receive audible sounds from a reader and analyze the received audible sounds to detect trigger phrases. Based upon the detected trigger phrases, an appropriate response such as an audible or visual effect may be initiated.

The system 100 may include a communication network 200 which operatively couples to the electronic device 101, the server 102, and the database 109. The electronic device 101 may include but not limited to one or more personal computers, laptop computers, display devices, video gaming systems, gaming consoles, mobile devices, smartphones or tablet computers.

The audio output module 107 may include a speaker, a sound controller , and various related circuitry (not shown), which may work with the sound controller to activate the speaker and to play audio effects stored in the database 109 or in the memory 105 in a manner known to one of ordinary skill in the art. The processor may be used by the audio output module and/or related circuitry to play the audio effects stored in the memory and/or the database .

The voice recognition module 106 may include a controller , and other related circuitry (not shown). The input unit 103, voice recognition controller, and the other related circuitry, may be configured to work together to receive and detect audible messages from the reader and detect trigger phrases and based upon the detected trigger phrase initiate an appropriate response (e.g., special effect). For each detected trigger phrase, a corresponding special effect may be stored in the memory 105 or the database 109. The voice recognition module 106 may employ at least one voice recognition algorithm.

The application of the system is configured to work with android devices including but not limited to kindle, computers, smart phones and tablets and provides interactive sound effects, illustrations and recordings while the users are reading a book to their children. Interactive sound effects, visual effects and animations integrated with the books, bring the story to life by adding music, sounds and even character voices. The app's voice recognition technology helps the sound effects become a seamless part of users narration.

In the description the term “app” or “application” or “mobile app” may refer to, for example, an executable program that is installed and runs on a computing device to perform one or more functions. It should be noted that one or more of the above components (e.g., the processor 104, the voice recognition module 106) may be operated in conjunction with the app as a part of the system 100.

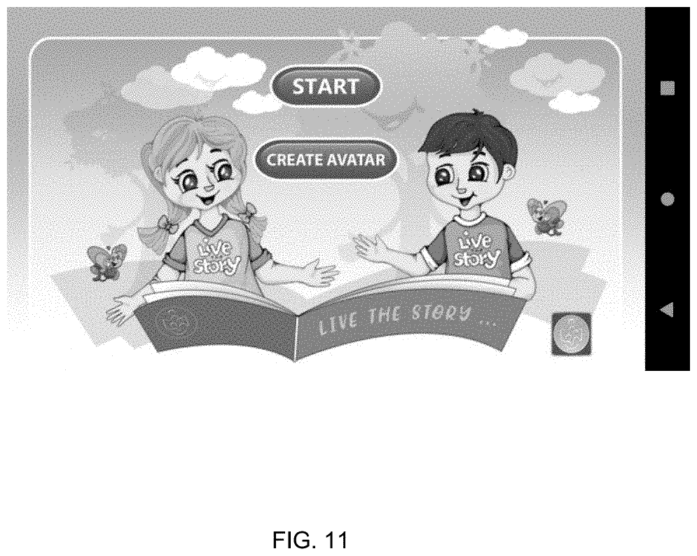

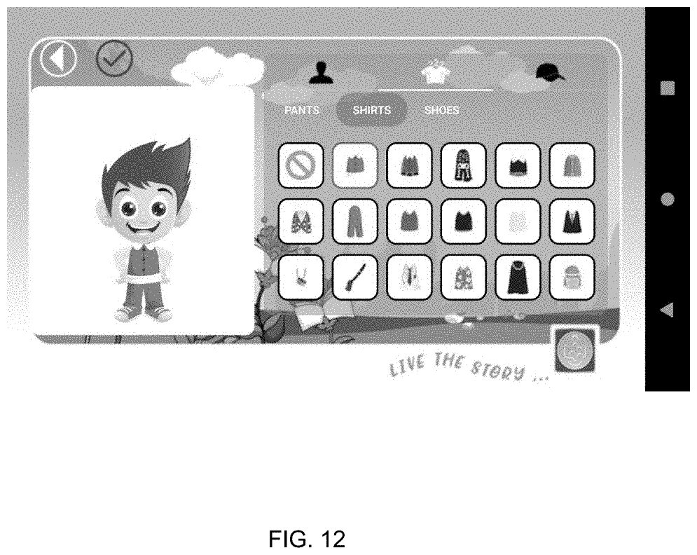

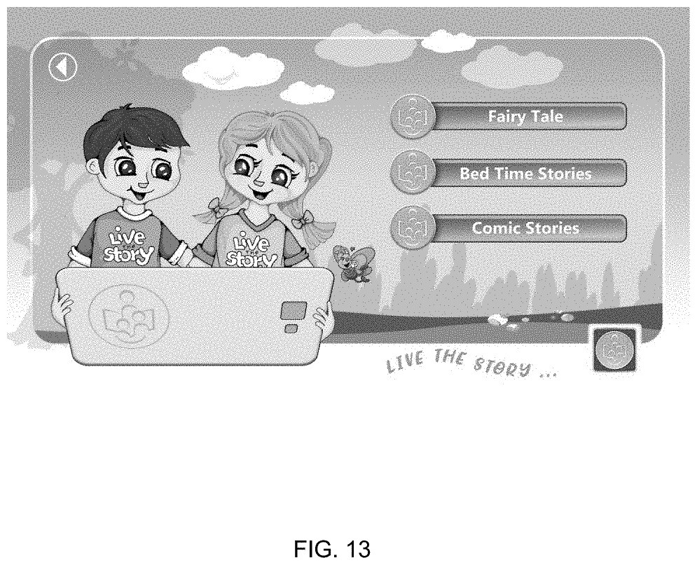

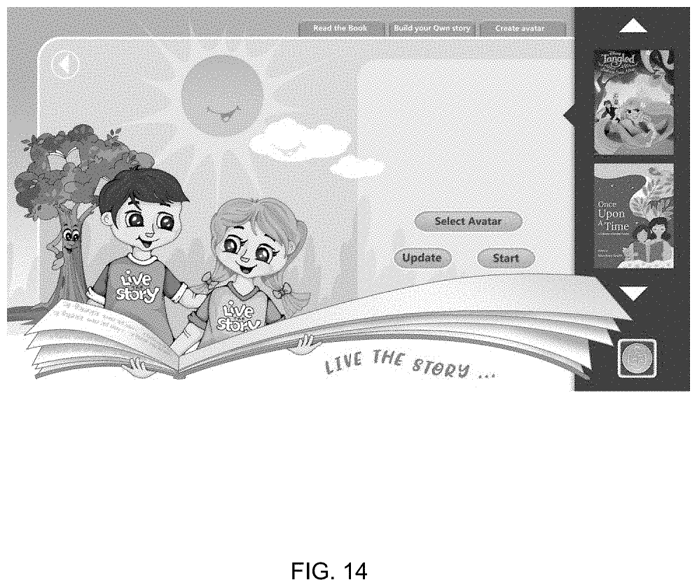

FIGS. 11 to 14 show the environment of the system.

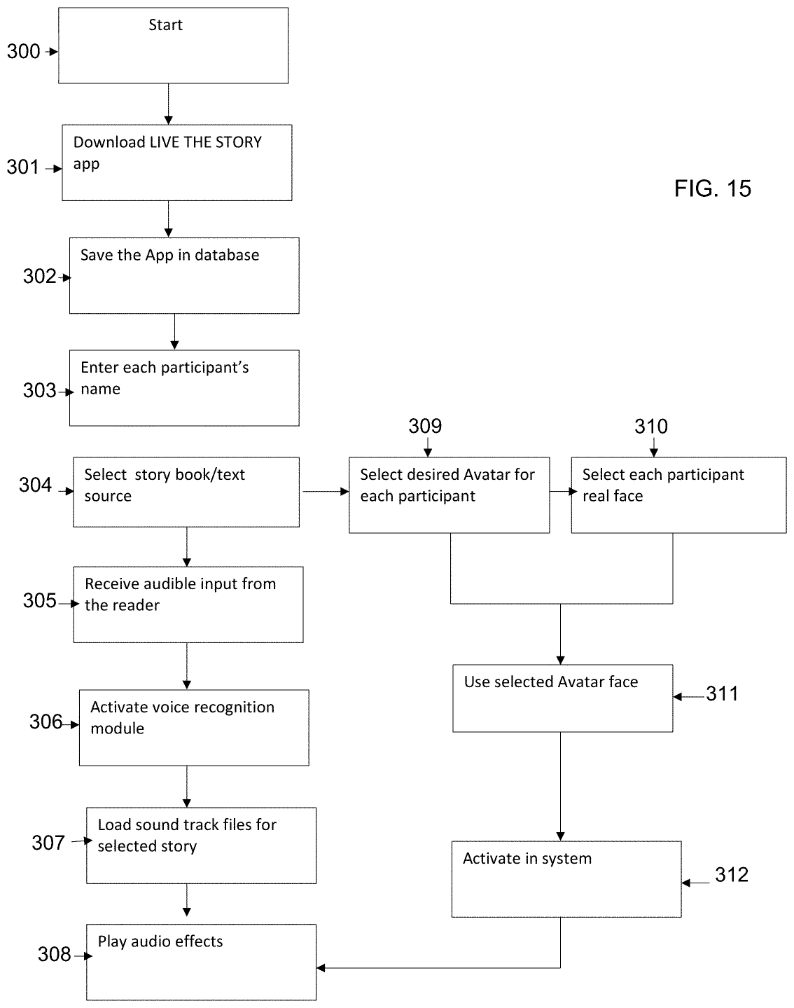

FIG. 15 describes a summary of the invention in a schematic format. The user starts 300 and downloads the “Live the story” app 301. The participant is asked to enter his/her name in the system. The name of the participant is saved in the system, which is then stored in the application data base 302. Multiple participants can log-in to the system to participate at the same time 303.

At block 304 the participant selects a text source from the system, the voice recognition module may be activated 306 to receive audible input from the reader 305, via the microphone of the input unit of the electronic device. the user may identify a text source she wishes to read aloud. Identification of the text source may be performed by the user entering a title of a text source, browsing for a text source title, or audibly speaking the name of a text source title.

At block 309 the participant is asked to select a desired avatar. The participant's real face can also be selected and saved in the application data base 310. At block 307, the application continuously picks up on audible messages, checks the audible input that matches to one or more pre-determined trigger phrases. Such a check may include comparing the spoken word(s) to word searchable files having an associated audio effect or soundtrack. The system load sound tracks and files for selected text source and plays the special effect associated with the one or more trigger phrases 308. The selected avatars are used 311 and activated in the system 312.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A system for generating an interactive story comprising:
an electronic device configured to:
receive an audible input of reading a story book from a user, and
access a plurality of pre-determined triggers associated with the story book,
wherein the electronic device is configured to cause one or more special effects matching the audible input to activate the plurality of pre-determined triggers, and wherein the electronic device is configured to output one or more special effects matching the audible input;
determine whether the audible input matches at least one of the plurality of pre-determined triggers via a voice recognition algorithm and command the electronic device to output a first special effect associated with the story book;
receive additional audible input from the user;
determine whether the additional audible input matches at least one of the pre-determined triggers via the voice recognition algorithm and command the electronic device to output a second special effect associated with the story book, wherein the second special effect is different than the first special effect;
continuously listen for and receive additional audible input from the user;
immerse one or more participants into the interactive story, wherein the input device take one or more pictures of one or more participants and select a picture of the one or more participant's face or create an avatar or select an avatar to interact with the interactive story.

2. The system of claim 1, wherein the electronic device comprises any one of computer devices including but not limited to smart phones, tablets, laptop computers, display devices, kindle and desktop computers.

3. The system of claim 1, wherein the first special effect comprises a first audio content.

4. The system of claim 1, wherein the second special effect comprises a second audio content.

5. The system of claim 1, wherein the story book may refer to a children's book, a board book, a chapter book, a novel, a magazine, a comic book, a text source and the like.

6. The system of claim 1, wherein the special effects comprises background images, characters, gif animations, environmental effects, sound effects and visual effects.

7. The system of claims 1 and 3, wherein the auditory effects include background music, human voices, animal sounds, atmospheric noises, sound effects and the like.

8. The system of claims 1 and 3, wherein the visual effects including any special effect that is designed to be viewable by a user comprising animation, video, avatars, light sources and the like.

9. The system of claim 1, wherein the audible input from the user comprising voice of the user reading one or more portions of the book electronically outputted.

10. A system for generating an interactive story comprising:
a computer program product comprising one or more no-transitory computer-readable medium having thereon computer-executable instructions that, when executed by one or more processors, cause the computing system to perform an interactive story, the interactive story generation comprising:
a story book selection mechanism that permits a reader to select one or more of the plurality of story books comprising a story editor mechanism that permits a reader to:
create and edit the story books;
add/edit text layers;
add/edit Background layers;
add/edit character layers;
add animations and motions layer, and
add visual and sound effects on the images and characters.

11. A method for an interactive story generation comprising:
receiving an audible input from a user on an electronic device comprising voice of the user reading one or more portions of a story;
accessing a plurality of pre-determined triggers associated with the story read by the user, wherein the electronic device is configured to cause one or more special effects upon matching the audible input to any of one or more pre-determined triggers;
determining whether the audible input matches at least two or more pre-determined triggers via a voice recognition algorithm;
determining that the audible input matches the at least one or more pre-determined triggers, command one or more special effects to output associated with the one or more portions of the story;
wherein the one or more special effects comprises a first special effect comprising a first audio output, and a second special effect comprising a second audio output different from the first special effect; and wherein the electronic device is configured to
determine when an additional pre-determined trigger phrase is detected via the voice recognition algorithm;
selecting an avatar for each participant from a display of one or more avatars of one or more characters in the story book;
generating an interactive story on the user interface and activating at least a special effect that matches the content of the story and at least one selected avatar in the system.
